(19) United States
(12) Patent Application Publication
(10) Pub. No.: US 2021/0209241 A1
(43) Pub. Date: Jul. 8, 2021

(54) Apparatus and method for data obfuscation of IoT device using pseudorandom number

(71) Applicant: GREEN ZONE SECURITY., LTD., Hyeonpung-myeon (KR)

(72) Inventor: Shin Kim, Gimpo-si (KR)

(21) Appl. No.: 16/965,259

(22) PCT Filed: Nov. 28, 2019
(86) PCT No.: PCT/KR2019/016603

§ 371 Date: Jul. 27, 2020

(30) Foreign Application Priority Data
Apr. 26, 2019 (KR) 10-2019-0049180

(51) Int. Cl. G06F 21/62; G06F 7/58

(52) U.S. Cl. CPC G06F 21/6218; G06F 7/582

(57) ABSTRACT

An apparatus for data obfuscation according to the present invention includes a memory, a random number generation module generating a plurality of pseudorandom numbers, and a data processing module splitting an identifier into a plurality of identifier pieces and storing the plurality of split identifier pieces in discontinuous addresses of the memory, respectively, based on the generated pseudorandom numbers.

### TECHNICAL FIELD

The present invention relates to a data obfuscation technology and, more particularly, to an apparatus and method for the data obfuscation of an IoT device using a pseudorandom number.

### BACKGROUND ART

An Internet of Things (abbreviated as an IoT) is a technology for embedding sensors and communication functions in various things and connecting the things to the Internet. That is, the IoT means a technology for connecting various things through wireless communication. The IoT is an artificial intelligence technology in which things connected through the Internet autonomously perform analysis by exchanging data and provide learnt information to a user or a user can remotely control the things. In this case, things include various embedded systems, such as home appliances, mobile equipment, and wearable devices. According to Gartner, an information technology research and consultancy, it is expected that the number of things using the IoT technology will reach 26 billion until 2020. If many things are connected as described above, massive data are collected through the Internet. The collected data are massive to the extent that it is difficult to analyze the data using the existing technology. This is called big data. A need for a technology to develop an efficient algorithm for analyzing big data comes to the fore along with the appearance of the IoT.

Things connected to the IoT need to be connected to the Internet using unique IPs capable of identifying the things. Sensors may be embedded in the things in order to obtain data from an external environment. The development of the IoT and the growth of security need to go together because all things may become the target of hacking.

### DISCLOSURE

### Technical Problem

An object of the present invention provides an apparatus and method capable of performing data obfuscation of an IoT device using a pseudorandom number.

### Technical Solution

To achieve the above object, an apparatus for data obfuscation according to an embodiment of the present invention includes a memory, a random number generation module generating a plurality of pseudorandom numbers, and a data processing module splitting an identifier into a plurality of identifier pieces and storing the plurality of split identifier pieces in discontinuous addresses of the memory, respectively, based on the generated pseudorandom numbers.

The random number generation module generates the same number of pseudorandom numbers as the number of identifier pieces, and the data processing module stores each of the identifier pieces at a location to which an offset based on a pseudorandom number from a preset reference address in the memory has been applied.

The data processing module generates the same number of secret key pieces as the number of identifier pieces by splitting a secret key when the secret key corresponding to the identifier is present, and encrypts each of the corresponding identifier pieces using each of the plurality of generated secret key pieces.

The data processing module generates the same number of secret key pieces x1, x2, . . . , xk as the number of identifier pieces by splitting the secret key according to an equation

$$a ( c ) = {\sum }_{j = 0}^{k - 1} {a}_{j} {c}^{j} mod p ,$$

wherein the c is the secret key, the p is a prime number greater than or equal to k+1, the x is k secret key pieces, and the a is a coefficient of a polynomial.

To achieve the object, a method for data obfuscation according to an embodiment of the present invention includes splitting, by a data processing module, an identifier into a plurality of identifier pieces, generating, by a random number generation module, the same number of pseudorandom numbers as the number of identifier pieces, and storing the plurality of split identifier pieces in discontinuous addresses of a memory, respectively, based on the generated pseudorandom numbers.

The step of storing includes storing, by the data processing module, each of the identifier pieces at a location to which an offset based on a pseudorandom number from a preset reference address in the memory has been applied.

The method further includes the steps of, after the step of splitting the identifier into the plurality of identifier pieces, before the step of generating the pseudorandom numbers, generating, by the data processing module, the same number of secret key pieces x1, x2, . . . , xk as the number of identifier pieces by splitting the secret key according to an equation

$$a ( c ) = {\sum }_{j = 0}^{k - 1} {a}_{j} {c}^{j} mod p ,$$

wherein the c is the secret key, the p is a prime number greater than or equal to k+1, the x is k secret key pieces, and the a is a coefficient of a polynomial.

### Advantageous Effects

According to the present invention, data storage security of an IoT device can be improved by performing data obfuscation using a pseudorandom number.

### DESCRIPTION OF DRAWINGS

FIG. 1 is a diagram for describing a configuration of an IoT system according to an embodiment of the present invention.

FIG. 2 is a block diagram for describing a configuration of a management apparatus according to an embodiment of the present invention.

FIG. 3 is a block diagram for describing a configuration of a device according to an embodiment of the present invention.

FIG. 4 is a flowchart for describing a method for data obfuscation according to an embodiment of the present invention.

FIG. 5 is a flowchart for describing a method for the data obfuscation of an IoT device using a pseudorandom number according to an embodiment of the present invention.

FIG. 6 is a concept view for describing a method of storing data in a memory according to an embodiment of the present invention.

### MODE FOR INVENTION

Prior to the detailed description of the present invention, terms or words used in the specification and claims described hereunder should not be construed as having common or dictionary meanings, but should be construed as having meanings and concepts that comply with the technical spirit of the present invention based on the principle that the inventor may appropriately define the concepts of the terms in order to describe his or her invention in the best manner. Accordingly, embodiments described in the specification and elements shown in the drawings are merely the most preferred embodiments of the present invention and do not fully represent the technical spirit of the present invention. Accordingly, it should be understood that a variety of equivalents and modifications capable of substituting the embodiments and elements at the time of filing of this application may be present.

Preferred embodiments of this invention are described in detail below with reference to the accompanying drawings. It is to be noted that the same reference numbers are used throughout the drawings to refer to the same elements. Furthermore, a detailed description of known functions or elements that may make the gist of this invention vague will be omitted. For the same reason, in the accompanying drawings, some elements are enlarged, omitted, or depicted schematically. Furthermore, the size of each element does not accurately reflect its real size.

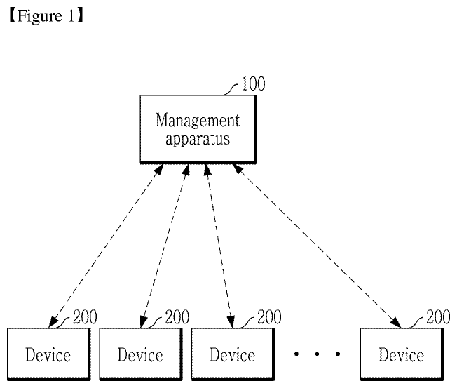

First, an IoT system according to an embodiment of the present invention is described below. FIG. 1 is a diagram for describing a configuration of the IoT system according to an embodiment of the present invention.

Referring to FIG. 1, the IoT system according to an embodiment of the present invention includes at least one management apparatus 100 and a plurality of Internet of Things (IoT) devices 200 (hereinafter abbreviated as “devices”).

The management apparatus 100 is for assigning identifiers (IDs) for identifying and managing the plurality of devices 200 and managing the plurality of devices 200 based on such IDs. The management apparatus 100 may generate an ID for each of the plurality of devices 200 and provide the generated ID through communication with the plurality of devices 200 over a network or may be directly connected to each of the plurality of devices 200 through wires and may inject the ID to each of the plurality of devices 200.

Each of the plurality of devices 200 is for providing an Internet of Things (IoT) service, and may be connected to a service server (not illustrated) for providing a given IoT service and provide a corresponding IoT service.

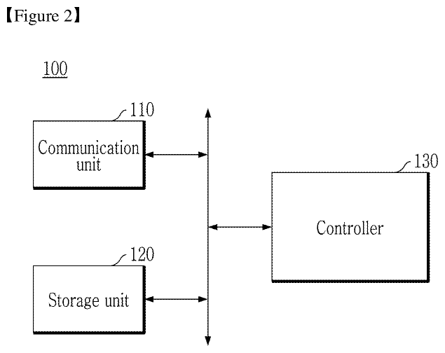

The management apparatus 100 is described more specifically below. FIG. 2 is a block diagram for describing a configuration of the management apparatus according to an embodiment of the present invention. Referring to FIG. 2, the management apparatus 100 includes a communication unit 110, a storage unit 120 and a controller 130.

The communication unit 110 is means for communication with the device 200. The communication unit 110 may include a radio frequency (RF) transmitter (Tx) for up-converting and amplifying the frequency of a transmitted signal and an RF receiver (Rx) for low-noise amplifying a received signal and down-converting the frequency of the received signal. Furthermore, the communication unit 110 includes a modem for modulating a transmitted signal and demodulating a received signal. The communication unit 110 may receive data from the device 200 and transmit the data to the controller 130, and may receive data from the controller 130 and transmit the received data to the device 200.

The storage unit 120 functions to store a program and data required for an operation of the management apparatus 100. In particular, the storage unit 120 may store the ID of each of the plurality of devices 200 managed by the management apparatus 100.

The controller 130 may control an overall operation of the management apparatus 100 and a flow of signals between blocks within the management apparatus 100, and may perform a data processing function for processing data. Furthermore, the controller 130 may basically function to control various functions of the management apparatus 100. The controller 130 may include a central processing unit (CPU), a digital signal processor (DSP), for example.

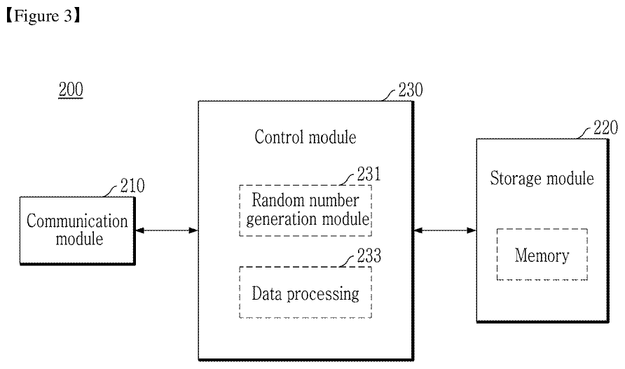

The device 200 according to an embodiment of the present invention is described below. FIG. 3 is a block diagram for describing a configuration of the device according to an embodiment of the present invention. Referring to FIG. 3, the device 200 includes a communication module 210, a storage module 220 and a control module 230.

The communication module 210 is means for communication with the management apparatus 100 or another device 200. The communication module 210 may include a radio frequency (RF) transmitter (Tx) for up-converting and amplifying the frequency of a transmitted signal and an RF receiver (Rx) for low-noise amplifying a received signal and down-converting the frequency of the received signal. Furthermore, the communication module 210 includes a modem for modulating a transmitted signal and demodulating a received signal. The communication module 210 may receive data from the control module 230 and transmit the data to the management apparatus 100 or another device 200. Furthermore, the communication module 210 receives data from the management apparatus 100 or another device 200 and transmits the data to the control module 230.

The storage module 220 stores a program and data required for an operation of the device 200. In particular, the storage module 220 may include a memory for the storage of data, etc. The memory may representatively include a random access memory (RAM). However, in the present invention, the memory is not limited thereto. Any storage medium capable of identifying and managing storage regions through addresses may be used regardless of the type of storage medium.

The control module 230 may control an overall operation of the device 200 and a flow of signals between blocks within the device 200, and may perform a data processing function for processing data. Furthermore, the control module 230 basically functions to control various functions of the management apparatus 100. The control module 230 may include a central processing unit (CPU), a digital signal processor (DSP), etc. The control module 230 includes a random number generation module 231 and a data processing module 233.

The random number generation module 231 is for generating a plurality of pseudorandom numbers. The data processing module 235 splits, into a plurality of ID pieces, an ID capable of uniquely distinguishing between the device 200 and another device, and stores the plurality of split ID pieces in discontinuous addresses of the memory of the storage module 220 using pseudorandom numbers generated by the random number generation module 233. An operation of the control module 230 including the random number generation module 231 and the data processing module 233 will be further described later.

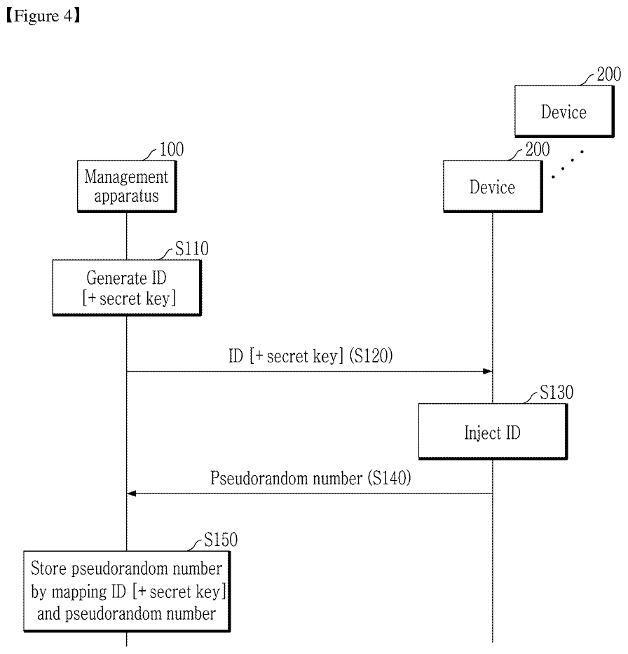

A method for data obfuscation according to an embodiment of the present invention is described below. FIG. 4 is a flowchart for describing a method for data obfuscation according to an embodiment of the present invention.

At step S110, the controller 130 of the management apparatus 100 generates an ID for identifying each of the plurality of devices 200. Furthermore, optionally, at step S110, the controller 130 of the management apparatus 100 may generate different secret keys (c) for the plurality of devices 200, respectively.

After generating the IDs and optionally the secret keys (c), at step S120, the controller 130 may provide the device 200 with an ID corresponding to the corresponding device 200 through a direct connection or wireless connection with the device 200 through the communication unit 110. In this case, if a secret key (c) corresponding to the corresponding device 200 is present, the controller 130 may provide the secret key (c) along with the ID.

At step S130, the control module 230 of the device 200 that has been provided with the ID stores the ID in the memory of the storage module 220. In this case, the control module 230 splits the ID into a plurality of ID pieces (id,k), generates pseudorandom numbers having the same number as the ID pieces (id,k), and stores the plurality of ID pieces (id,k) in discontinuous addresses of the memory, respectively, by applying an offset from a reference address in which the ID is stored based on the generated pseudorandom numbers. Meanwhile, if the control module 230 is additionally provided with the secret key (c), the control module 230 may generate secret key pieces (x,k) having the same number as the ID pieces (id,k) by splitting the secret key (c) before storing the ID pieces (id,k) in the memory, and may then encrypt the ID pieces (id,k) into corresponding secret key pieces (x,k), respectively.

After the ID pieces (id,k) are stored in the memory as described above, at step S140, when storing the ID pieces (id,k) in the memory, the control module 230 of the device 200 transmits, to the management apparatus 100, the plurality of pseudorandom numbers used as the offset from the reference address. In this case, the control module 230 may transmit the pseudorandom numbers to the management apparatus 100 through a direct or wireless connection with the management apparatus 100 using the communication module 210.

At step S150, the controller 130 of the management apparatus 100 that has received the pseudorandom numbers may store, in the storage unit 120, the corresponding pseudorandom numbers by mapping the corresponding pseudorandom numbers to the ID of the corresponding device 200. If the secret key (c) is present, the controller 130 may store the ID, the secret key (c), and the pseudorandom numbers in the storage unit 120 by mutually mapping the ID, the secret key (c), and the pseudorandom numbers.

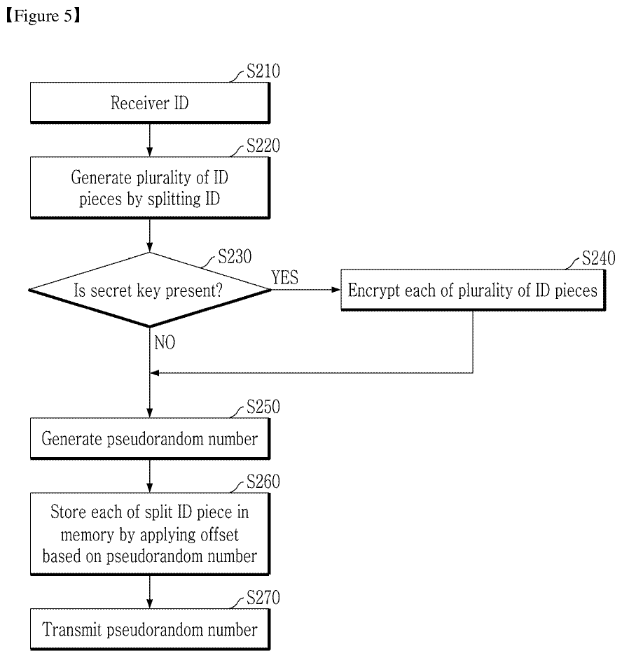

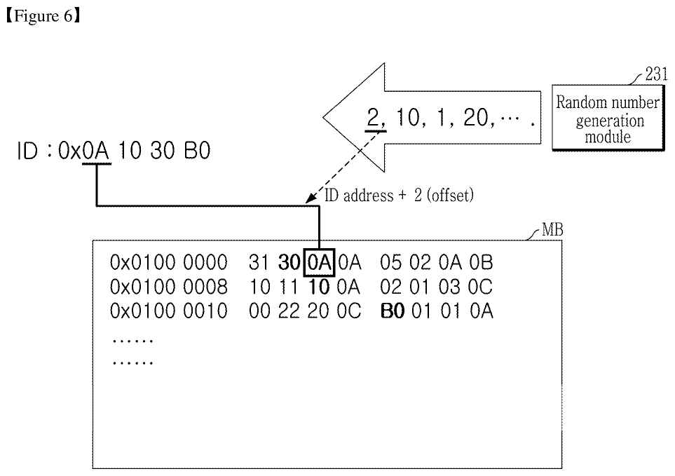

A method for the data obfuscation of an IoT device using a pseudorandom number according to an embodiment of the present invention is described below. FIG. 5 is a flowchart for describing a method for the data obfuscation of an IoT device using a pseudorandom number according to an embodiment of the present invention. FIG. 6 is a concept view for describing a method of storing data in a memory according to an embodiment of the present invention.

Referring to FIG. 5, at step S210, the data processing module 233 may receive, from the management apparatus 100, an ID capable of identifying the device 200 from another device through a direct connection or a wireless connection with the management apparatus 100. Such an ID may have been generated by the management apparatus 100. If the management apparatus 100 has provided a secret key (c) at step S210, optionally, the data processing module 233 may additionally receive the secret key (c) along with the ID.

Next, at step S220, the data processing module 233 generates a plurality of (k wherein k is a natural number) ID pieces (id,k) id1, id2, . . . , idk by splitting the received ID. Preferably, the data processing module 233 may split the ID in a byte unit.

At step S230, the data processing module 233 determines whether a secret key (c) provided by the management apparatus 100 is present. If, as a result of the determination, the secret key (c) is present, the data processing module 233 proceeds to step S240. If the secret key (c) is not present, the data processing module 233 proceeds to step S250.

If, as a result of the determination at step S230, the secret key (c) is present, if the secret key (c) has been provided, the data processing module 233 encrypts each of the plurality of ID pieces (id,k) using the secret key (c) at step S240. Such encryption is described more specifically below.

First, the data processing module 233 generates secret key pieces (x,k) having the same number (k) as the number (k) of ID pieces (id,k) by splitting the secret key (c).

For example, when the number of ID pieces (id,k) is k (wherein k is a natural number), the data processing module 233 may generate k secret key pieces (x,k) by splitting the secret key (c) according to Equation 1 below.

$$a ( c ) = {\sum }_{j = 0}^{k - 1} {a}_{j} {c}^{j} mod p = ( {a}_{0} + {a}_{1} c + {a}_{2} {c}^{2} + … + {a}_{k - 1} {c}^{k - 1} ) mod p = x 1 + x 2 + … + xk \qquad [ Equation 1 ]$$

In this case, c is the secret key, p is a prime number greater than or equal to k+1, x is the k secret key pieces, and a is a coefficient of a polynomial and is randomly selected.

That is, the data processing module 233 may generate the k secret key pieces (x,k) x1, x2, . . . , xk according to Equation 1.

After generating the plurality (k) of secret key pieces (x,k), the data processing module 233 encrypts each of the corresponding ID pieces (id,k) using each of the plurality of secret key pieces (x,k).

For example, the data processing module 233 may encrypt each of the ID pieces (id,k) using each of the secret key pieces (x,k) as in Equation 2 below.

id1⊕x1,id2⊕x2, . . . ,idk⊕xk [Equation 2]

In this case, it has been described that the ID pieces (id,k) is encrypted through an exclusive OR operation, but the present invention is not limited thereto. The type of operation is not limited to any operation for encrypting each of the ID pieces (id,k) using a secret key piece (x,k) corresponding to each of the ID pieces (id,k).

Meanwhile, if, as a result of the determination ate step S230, the secret key (c) is not present or after step S240 is completed, at step S250, the random number generation module 231 (or pseudorandom number generator (PRNG)) generates a plurality of pseudorandom numbers. In this case, the random number generation module 231 generates pseudorandom numbers having the same number (k) as the number (k) of ID pieces (id,k). In this case, the random number generation module 231 generates n pseudorandom numbers so that the n pseudorandom numbers do not overlap a number from 1 to m.

Next, at step S260, the data processing module 233 stores each of the ID pieces (id,x) at a location to which an offset based on a pseudorandom number from a preset reference address in a memory has been applied.

That is, the random number generation module 231 generates the same number (k) of pseudorandom numbers as the number (k) of ID pieces (id,k). Accordingly, the pseudorandom numbers correspond to the respective ID pieces (id,k) according to their sequence. The random number generation module 231 stores each of the ID pieces (id,k) at a location (address) to which an offset based on a corresponding pseudorandom number from a reference address in a memory has been applied. An example in which each of the ID pieces (id,x) is stored in the memory by applying an offset based on a pseudorandom number as described above has been illustrated in FIG. 6.

As shown, it is assumed that an ID is 0x0A 10 30 B0 and has been split in a byte unit and split into 4 (k=4) ID pieces (0x0A, 10, 30, B0). Furthermore, it is assumed that pseudorandom numbers generated by the random number generation module 231 are 2, 10, 1, and 20. Furthermore, it is assumed that a reference address at which the ID of a memory block is stored is “0x0100 0000.”

Accordingly, as illustrated in FIG. 6, the data processing module 233 stores the first ID piece (0x0A) at a location to which an offset of 2, that is, a pseudorandom number generated from the reference address, has been applied.

Likewise, the data processing module 233 stores the second ID piece (10) at a location offset by 10, that is, a pseudorandom number generated from the reference address, stores the third ID piece (30) at a location offset by 1, that is, a pseudorandom number generated from the reference address, and stores the fourth ID piece (B0) offset by 20, that is, a pseudorandom number generated from the reference address.

After storing the plurality of ID pieces in the memory through the pseudorandom numbers as described above, at step S270, the data processing module 233 may transmit the generated pseudorandom numbers to the management apparatus 100.

If an ID or data is stored using the method according to an embodiment of the present invention, a value of the ID or data cannot be known by simply reading a memory and values of pseudorandom numbers generated by an individual device area different. Accordingly, a level of security is improved because the hacking of any one device cannot be applied to the other device without any change.

Meanwhile, the aforementioned methods according to the embodiments of the present invention may be implemented in the form of a program readable through various computer means, and may be written in a computer-readable recording medium. In this case, the recording medium may include program instructions, a data file, and a data structure alone or in combination. The program instructions written in the recording medium may be specially designed and constructed for the present invention, or may be known and available to those skilled in computer software. For example, the recording medium include magnetic media such as a hard disk, a floppy disk and a magnetic tape, optical media such as a CD-ROM and a DVD, magneto-optical media such as a floptical disk, and hardware devices specially configured to store and execute program instructions, such as a ROM, a RAM, and a flash memory. Examples of the program instructions may include not only a machine language wire constructed by a compiler, but a high-level language wire capable of being executed by a computer using an interpreter. Such a hardware device may be configured to act as one or more software modules in order to perform an operation of the present invention, and vice versa.

Although the present invention has been described using some preferred embodiments, these embodiments are illustrative and are not restrictive. As described above, a person having ordinary knowledge in the field to which the present invention pertains may understand that the present invention may be variously changed and modified based on doctrine of equivalents without departing from the spirit of the present invention and the range of rights described in the claims.

### INDUSTRIAL APPLICABILITY

The present invention can improve data storage security of an IoT device by performing data obfuscation using a pseudorandom number. Accordingly, the present invention has the industrial applicability because it can be sufficiently available or on the market and practically implemented evidently.

1. An apparatus for data obfuscation, comprising:
a memory;
a random number generation module generating a plurality of pseudorandom numbers; and
a data processing module splitting an identifier into a plurality of identifier pieces and storing the plurality of split identifier pieces in discontinuous addresses of the memory, respectively, based on the generated pseudorandom numbers.

2. The apparatus of claim 1, wherein:
the random number generation module generates the same number of pseudorandom numbers as the number of identifier pieces, and
the data processing module stores each of the identifier pieces at a location to which an offset based on a pseudorandom number from a preset reference address in the memory has been applied.

3. The apparatus of claim 1, wherein the data processing module
generates the same number of secret key pieces as the number of identifier pieces by splitting a secret key when the secret key corresponding to the identifier is present, and
encrypts each of the corresponding identifier pieces using each of the plurality of generated secret key pieces.

4. The apparatus of claim 3, wherein:
the data processing module generates the same number of secret key pieces x1, x2, . . . , xk as the number of identifier pieces by splitting the secret key according to an equation
$$a ( c ) = {\sum }_{j = 0}^{k - 1} {a}_{j} {c}^{j} mod p ,$$
wherein the c is the secret key,
the p is a prime number greater than or equal to k+1,
the x is k secret key pieces, and
the a is a coefficient of a polynomial.

5. A method for data obfuscation, comprising:
splitting, by a data processing module, an identifier into a plurality of identifier pieces;
generating, by a random number generation module, the same number of pseudorandom numbers as the number of identifier pieces; and
storing the plurality of split identifier pieces in discontinuous addresses of a memory, respectively, based on the generated pseudorandom numbers.

6. The method of claim 5, wherein the step of storing comprises storing, by the data processing module, each of the identifier pieces at a location to which an offset based on a pseudorandom number from a preset reference address in the memory has been applied.

7. The method of claim 5, further comprising steps of:
after the step of splitting the identifier into the plurality of identifier pieces, before the step of generating the pseudorandom numbers,
generating, by the data processing module, the same number of secret key pieces as the number of identifier pieces by splitting a secret key when the secret key corresponding to the identifier is present; and
encrypting each of the corresponding identifier pieces using each of the plurality of generated secret key pieces.

8. The method of claim 7, wherein the step of generating the same number of secret key pieces as the number of identifier pieces by splitting the secret comprises generating, by the data processing module, the same number of secret key pieces x1, x2, . . . , xk as the number of identifier nieces by splitting the secret key according to an equation
$$a ( c ) = {\sum }_{j = 0}^{k - 1} {a}_{j} {c}^{j} mod p ,$$
wherein the c is the secret key,
the p is a prime number greater than or equal to k+1,
the x is k secret key pieces, and
the a is a coefficient of a polynomial.
